(19) United States
(12) Patent Application Publication
(10) Pub. No.: US 2004/0212988 A1
(43) Pub. Date: Oct. 28, 2004

(54) Illumination devices using LEDs

(76) Inventor: Michelle Jillian Fuwausa, Columbia, MD (US)

Correspondence Address: GOTTLIEB RACKMAN & REISMAN PC, 270 MADISON AVENUE, 8TH FLOOR, NEW YORK, NY, 100160601

(21) Appl. No.: 10/609,196

(22) Filed: Jun. 28, 2003

Related U.S. Application Data
(60) Provisional application No. 60/465,460, filed on Apr. 28, 2003.

(51) Int. Cl. F21V 21/08

(52) U.S. Cl. 362/103

(57) ABSTRACT

A watch or other illuminated device is formed with a case, a crystal and a watch face which is at least partially disposed at an angle with respect to the watch crystal. The watch face bears indicia including numerals and/or designs and logos that are selectively illuminated by a radiation source disposed at or in a lateral wall of the watch case and oriented to emit radiation for illuminating the indicia. The radiation source may be a UV LED in which case the indicia include a UV reactive material that renders the indicia visible in the presence of UV radiation.

### RELATED APPLICATIONS

This application claims the benefit of U.S. Provisional Application Serial No. 60/465,460 filed Apr. 28, 2003, entitled “Illuminated devices using UV-LED's”.

The subject matter of this application is related to U.S. patent application Ser. No. 10/139,660 filed May 3, 2002, entitled “Illumination Devices for Watches and Other Instruments”, incorporated herein by reference.

### BACKGROUND OF THE INVENTION

a. Field of Invention

This invention relates generally to improvements in illumination devices such as electronic timepieces and instrumentation equipped for digital or analog display, and other similar articles, which are illuminated for viewing under poor lighting conditions, and provides improvements to the subject matter disclosed in my U.S. patent application entitled “Illumination Devices for Watches and other Instruments”, defined above.

b. Description of the Prior Art

The aforementioned patent application disclosed an ultraviolet light source radiating onto a treated surface and it has been found that the light source can be moved to the outer perimeter and still remain effective so long as the devices surface is angled towards the radiating light source. Furthermore, since a watch has limited internal space, positioning the light source on the outer perimeter and angling the surface provided maximum distance within the confined interiors case, providing a more even distribution of illumination.

Historically, watches and instrumentation and similar articles were first illuminated using phosphorescent markings. Other means include the use of LED, LCD, and fluorescent devices, as well as incandescent bulbs. All of these proved to be unsatisfactory, especially for small devices such as wristwatches.

It is key that the illuminating device provides an even distribution of illumination, which has been a drawback to the previously mentioned devices.

Electroluminescent lighting, hereinafter referred to as EL, was introduced, for digital and analog watches as another known alternative. An EL element is positioned underneath the watch dials, or other surfaces, or alternatively the dials themselves are made of EL material, as described in U.S. Pat. No. 3,749,977 to Sliker and U.S. Pat. No. 4,775,964 to Alessio & Olsen. In all of these references, direct illumination is projected upward towards the viewer, restricting any aesthetic aspects such as a full color logo or images on the dial. Another disadvantage of EL is that they require complicated auxiliary circuitry. Moreover, they are limited commercially to colors such as blue-green, white and yellow.

U.S. Pat. No. 5,984,485 to Poli et al., discloses a uniform LED illumination device for the dial of a display device.

U.S. Pat. No. 5,604,716 to Cheung, discloses a black light illuminated analog watch using an ultraviolet tube.

In my U.S. Pat. Nos. 6,106,127 and 6,299,321 and U.S. Patent Application Publication No. 2002/0176245 (pending), I have described an illumination device for a watch and other instruments consisting of a visible and ultraviolet light emitter. The following concepts comprise various improvements to the basic patented invention of these patents.

### OBJECTIVES AND SUMMARY OF THE INVENTION

It is an objective to improve illumination in the prior art and provide an improved system through which sufficient illumination can be provided to both indicia of interest as well as logos and other decorative elements.

It is another objective of the present invention to provide an improved illumination device for an electronic or analog timepiece or instrumentation eliminating inefficient illumination sources and its associated circuitry.

Another objective of the invention is to provide an improved illumination apparatus for viewing the dial or surfaces of instrumentation by positioning an illumination device on the outer perimeter and angling the dial surface towards the illumination device. This angled surface will provide a direct path of the emitted radiation to the surfaces treated indicia increasing the absorption and therefore increasing its efficiency.

Another objective of the invention is to provide improved illumination in low light or at nighttime, the illumination of multiple color images, logos, numbers or designs located on or in close proximity of a watch or instrumentation face.

A further objective is to provide a solid-state illumination device, which utilizes a UV light source providing a novel type of illumination for watches and instrumentation.

The present invention seeks to attain these objectives by disposing a radiation emitting device in close proximity of the article to be illuminated. This element could be positioned on the sides, embedded in the outer case or on a post providing a wide or focused radial pattern to the surface and is activated by means of an electronic circuit which is installed with said article. An actuator button is provided on the case of the article for selectively activating the light-emitting element.

The light source is disposed either on the outer perimeter, embedded in the case or on a post, in such a manner that is aesthetic and virtually invisible while providing an even distribution of illumination.

### BRIEF DESCRIPTION OF THE DRAWINGS

The invention will be better understood by reference to the following description, taken in connection with the appended drawings, in which the reference numerals indicate the parts, and in which,

FIG. 1 shows a cross-sectional view of a watch with an angled watch face, in accordance with this invention.

FIG. 2 shows the front view of a square watch with a light source.

FIG. 3 shows the front view of a round watch with a light source.

FIG. 4 shows the front view of the round watch with illumination pattern from the radiation emitting device.

FIG. 5 shows a side sectional view of the watch of FIG. 4.

FIGS. 5A and 5B show a side sectional view of another embodiment.

FIG. 6A shows a front view of a watch with a light source embedded in the watch face.

FIG. 6B shows an enlarge side sectional view of the watch face of FIG. 6A.

FIG. 7A shows a front view of a watch with another light source embedded in the watch face.

FIG. 7B shows an enlarged side sectional view of the watch of FIG. 7A.

FIG. 8A shows a front view of a watch with an alternate light source embedded in the watch face.

FIG. 8B shows an enlarged side sectional view of the watch of FIG. 8A.

FIG. 9 shows a side sectional view of another embodiment of a watch with a (partially) angled watch face.

FIG. 10A shows a front view of a third embodiment of the invention with two angled watch face portions.

FIG. 10B shows a partial side sectional view of the watch face used in the embodiment of FIG. 10A.

FIG. 11 shows a partial side sectional view of a watch with the watch face of FIGS. 10A and 10B.

### DETAILED DESCRIPTION OF THE DRAWINGS

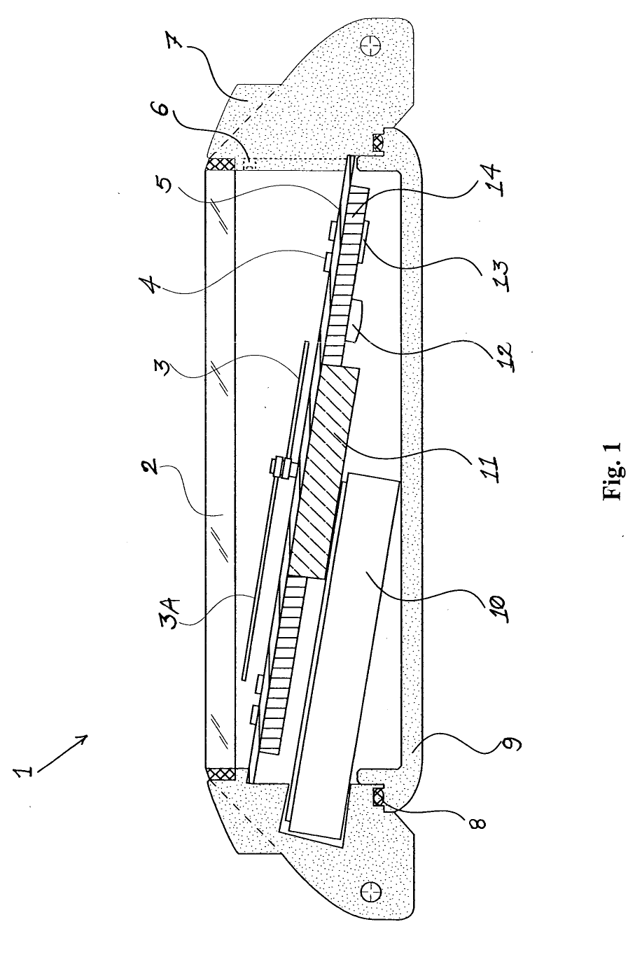

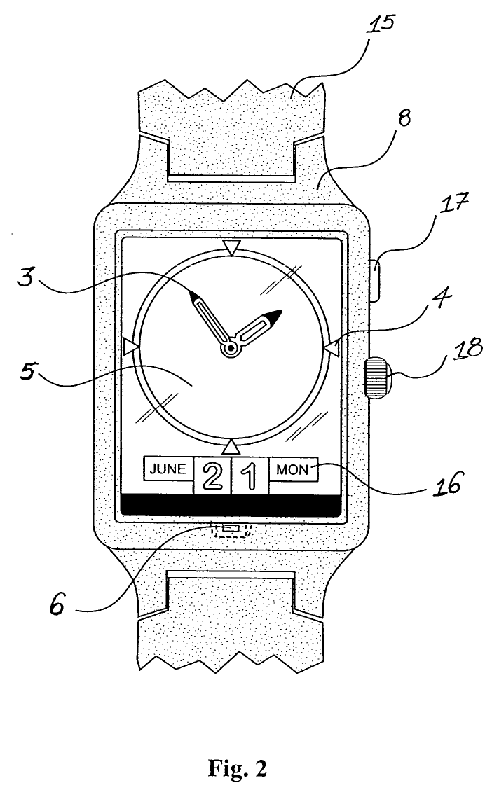

Referring now to FIGS. 1 and 2, a wristwatch 1 is shown with a rounded case 7 and a crystal 2. Hour and minute hands 3 and 3A display the time and are connected to a watch movement 11. The watch face 5 could be angled with the top of the watch face. Appropriate indicia are provided on the face that may include an image, a logo and/or numerals 4. The indicia may be treated with phosphorescent, fluorescent or UV reactive materials.

A radiation emitting device 6, preferably a UV-LED, which may be in the form of a packageless device, a raw dice, a chip, surface mounted ceramic, tin can package, or a UV resistant epoxy package. The device 6 is mounted in a cavity in the watch case or along the outer perimeter of the watch case interior. Wires or contacts (not shown) run from the contacts (not shown) of the device 6 along the outer perimeter down to the undersurface of the watch face and make contact with the connectors of a circuit board 14. The circuit board 14 could be in the shape of a crescent or oval, and is used to mount a control mechanism for controlling the operation of the device 6. The control mechanism could include a preprogrammed ASIC chip 12 and a switched-capacitor voltage converter 13 that delivers a regulated output using power from a 3 volt button cell battery 10. The watch case 7 includes a back 9 and a rubber O-ring 8 used to seal the case.

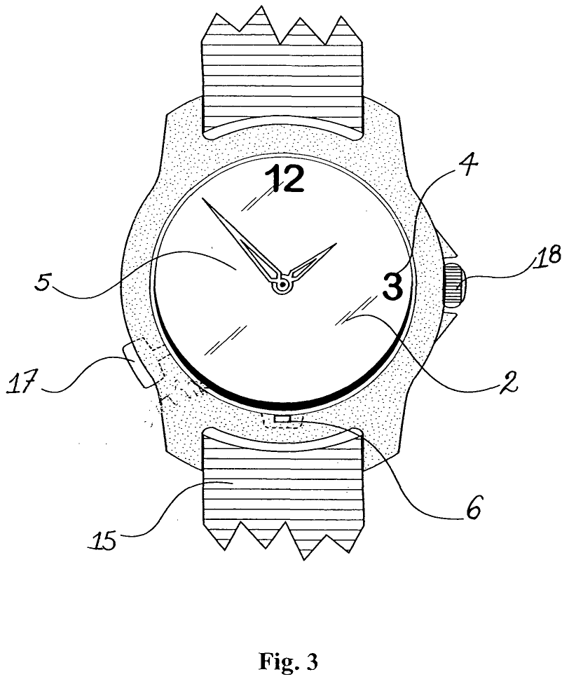

Referring now more particularly to FIGS. 2, 3 and 4, the case can have a square shape or a round shape. As shown in these Figures, the face may also be provided with a day, date and month indicator 20. The position of the hands may be adjusted using knob. The case 7 is attached to a watchband 15 by a suitable means 8.

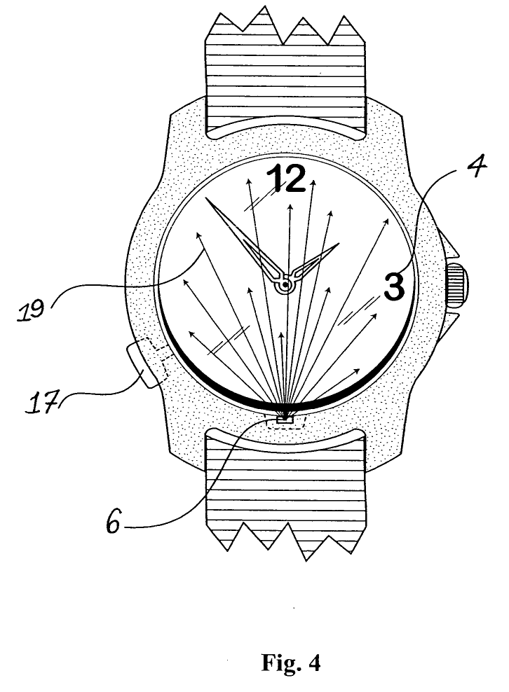

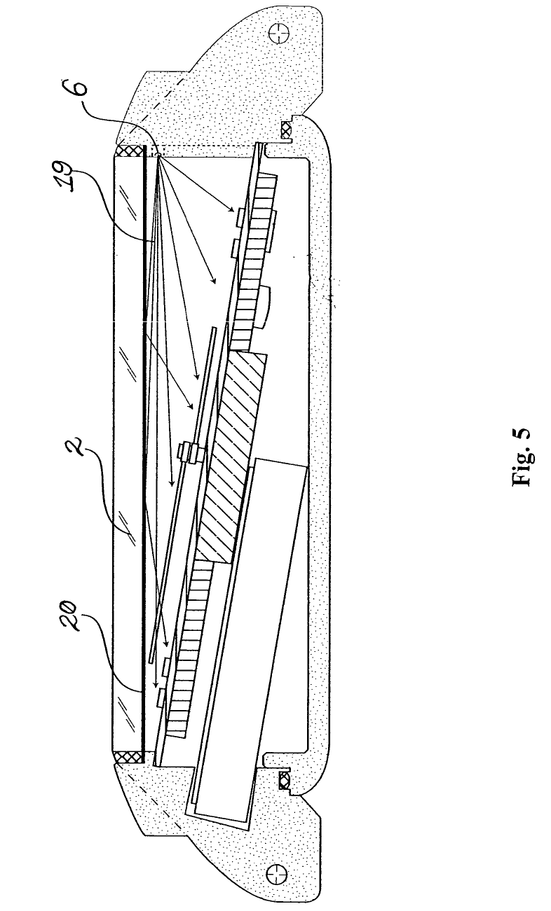

Power to the device 6 is selectively applied by a user through an actuator button 17. As shown in FIGS. 4 and 5, when activated, device 6 illuminates the indicia 4 thereby rendering the same visible at night. More particularly, the device emits electromagnetic radiation in a pattern 19 that directly intersects or is incident on the watch face and its indicia 4. In addition, the crystal 2 is advantageously coated with a reflective material that further directs some of the radiation downward. This latter feature is especially effective if the indicia 4 consists of or contains materials reactive to UV light (that is, materials that glow or emit visible light when exposed to UV light) because the UV reflective coating is transparent to normal light and hence invisible. The UV reflective coating 20 provides maximum reflection of the radiation to the watch face therefore improving efficiency. The UV coating 20 could also provide a protective barrier, preventing UV radiation from exiting the watch crystal, towards the viewer.

Another embodiment of the invention is shown in FIGS. 5A and 5B. In embodiment, the watch face 5 is disposed in parallel to the crystal 2 As in FIGS. 1-5, a radiation emitting device 6, preferably a UV-LED, is positioned on the outer perimeter of the watch face or in a cavity in the watch case but nonetheless emitting radiation outward onto the watch face 5 with a wide radial pattern 19 as described in FIG. 5. The device 6 is able to excite the indicia 4 with UV light even without angling the watch face because the UV reflective coating 20 applied to the underside of the watch crystal 2 reflects the UV radiation back towards the watch face with its indicia 4. Moreover, the watch face 5 may be coated with a UV reflective material 21A as well.

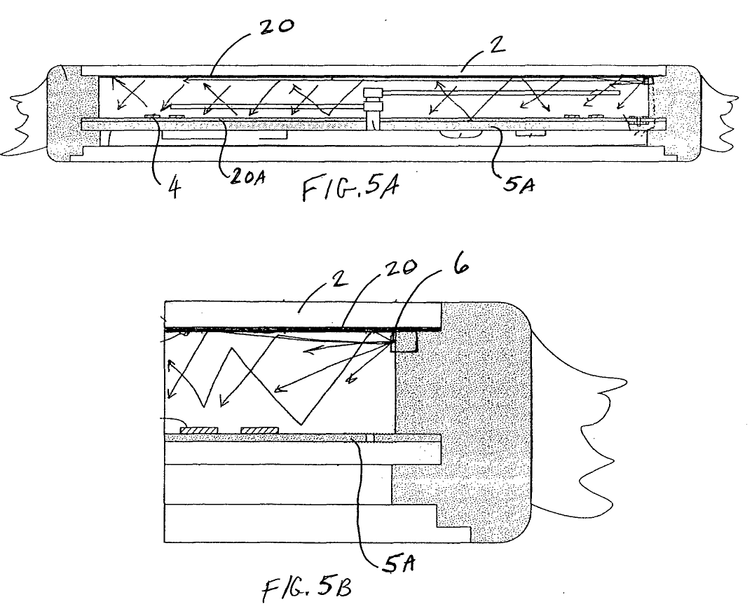

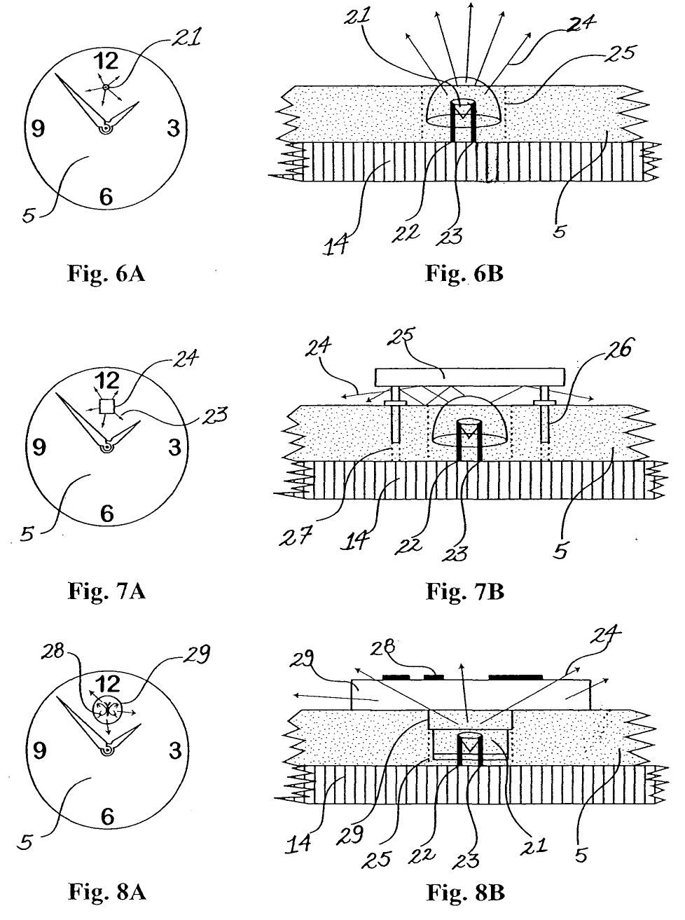

FIGS. 6A, 7A and 8A shows the front view of a watch face 5 while FIGS. 6B, 7B and 8B shows the side view of a watch face 5 and circuit board 14 and are arranged to permit illumination whether for visual aesthetics or as a functional warning device.

FIGS. 6A and 6B show a watch face 5 with an electromagnetic radiation in a pattern 24, preferably from a light emitting device such as an LED 21. As seen in FIG. 6B the device 21 is positioned inside of cavity 25. The device 21 has an anode 22 and cathode 23 connected to the circuit board 14, and a switch (not shown). The device 21 could be programmed to activate when the switch is pressed or could be activated to blink when the primary battery for illumination is low therefore alerting the wearer.

FIGS. 7A and 7B show a light emitting device 21 emitting light in a radial pattern 23 reflecting off of an opaque or transparent covering 34. The device 21 is again embedded in the watch face. The covering which can be shaped to form design, or logo, or carry a design or a logo and is supported by columns and spacers 26 which fit into drilled or punched holes 27 and extend above the watch face 5. The anode and the cathode 22 and 23 of the device 21 are connected to a power source (not shown).

FIGS. 8A and 8B show an embodiment similar to the embodiment of FIGS. 7A and 7B but with the device 21 being covered with a transparent translucent substrate 29 is mounted directly on the top surface of the watch face 5. The substrate 29 is provided with a image, design, logo or indicia 28 on its surface The clear or translucent substrate 29 has a protrusion 29A which fits into the cavity 25 of the watch face 5 and is planar on the end, fitting against the planar surface of a device 21 preferably a red LED. The device 25 is positioned inside of said cavity 25 and emits radiation in a radial pattern 24 that passes through the clear or translucent substrate 29.

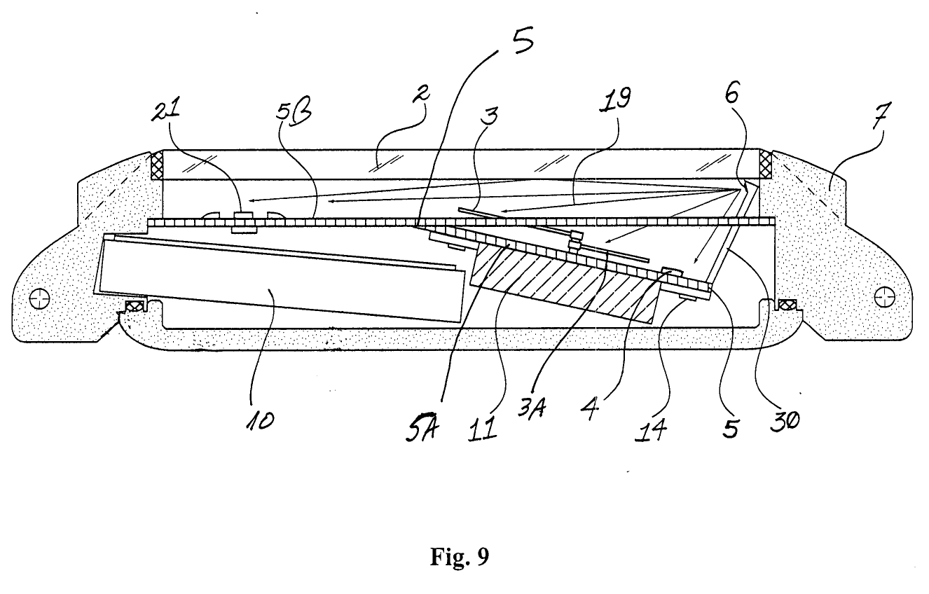

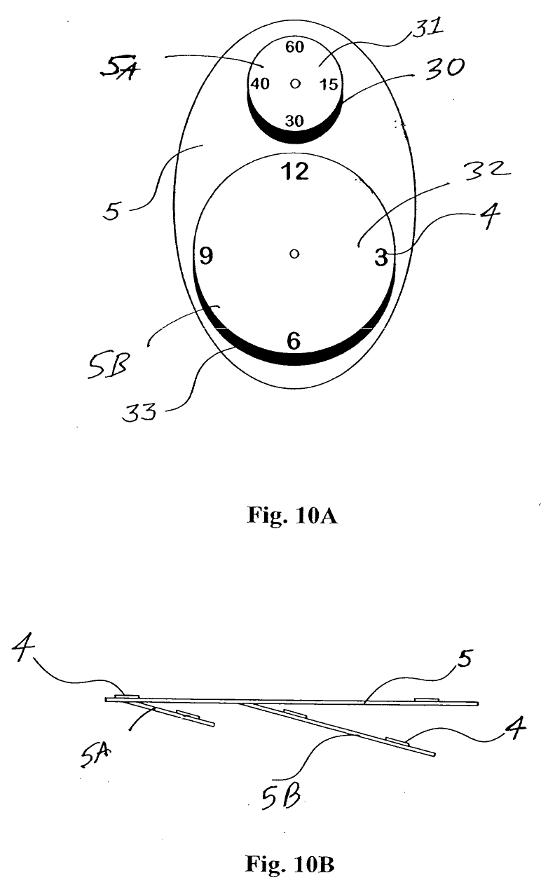

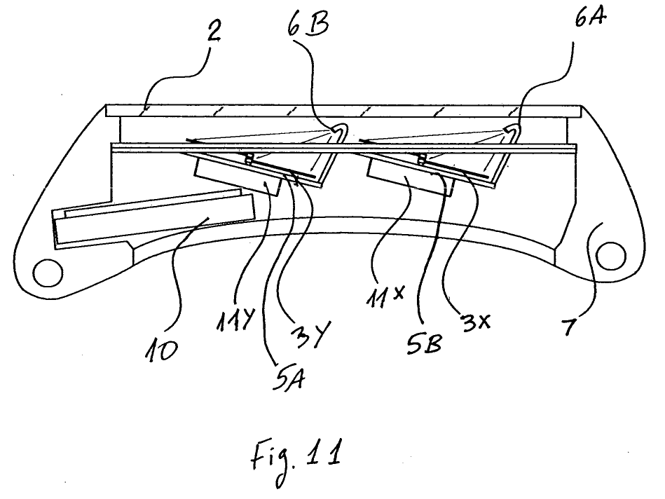

FIG. 9 shows a wristwatch similar to the one in FIG. 1 but with an oval shaped case 7 (similar to the case of the embodiment of FIGS. 10A and 10B, discussed below) and a crystal 2 with a watch face 5 with a minute and hour hands 3 connected to a watch movement 11. An angled arm 30 is used to support and provide electrical contacts to radiation emitting device 6. The wires for the electrical contact are coupled to a circuit board 11 with a power converter and a 3 volt button cell battery 10 as a power source. When activated by an actuator button (not shown) it causes the device 6 (that is preferably a UV LED) to emit radiation to excite indicia, image, logo or design 4 as well as hands 3 and 3A.

Importantly, while the portion 5A of the watch face forming a watch is angled in a manner similar to the embodiments of FIGS. 1-4, a second portion 5B of the watch face one portion of the watch face 5 is straight and generally parallel to the crystal 2. The portion 5B includes an imbedded radiation emitting device 21 as described in FIGS. 6A, 6B, 7A, 7B or 8A and 8B. The abrupt angle between portions 5A and 5B provides additional distance from watch face 5A and the radiation emitting device 6 leading to a better overall illumination thereof. The portion 5A could be formed by making an arcuate cut in the watch face 5 and bending it downward in the position shown. The battery 10 can be nested inside the case at an angle as well, as seen in FIG. 9 to take advantage of the geometrical space available inside the case.

FIGS. 10A and 10B shows a front view and a side view of another alternate embodiment of the invention. In this embodiment the watch face 5 is again substantially parallel to the crystal of the watch and is formed with two portions 5A and 5B which are both angled downward as indicated in FIG. 10B. The two portions 5A and 5B can be formed by making arcuate cuts 30 and 33 in the watch face. As shown in FIG. 11, the two portions are used to form two separate dials 31 and 32, each with its movement 11X and 11Y and one or more hands 3× and 3Y (not shown) that are moved across the dials. Dial 32 could be used to indicate the hours and the minutes, while dial 31 could be used to indicate seconds, a data, or other information. The indicia on the dial 32, including the numerals and any other markings, such as logos, and other designs are illuminated by a radiation emitting device 6 identical to the one shown in FIG. 9. In some cases, depending on the size of the watch and the optical characteristics of the device 6, sufficient radiation may be generated by device 6 to illuminate both dials. Otherwise, two separate devices 6A and 6B may be provided on respective posts depending from the watch face portions. Power to the movement and the radiation devices 6A and 6B is derived from battery cell 20.

The invention was described specifically in conjunction with watches, and more specifically wrist watches. Of course the principles of the invention can be used as well in other kinds of watches, clocks, and as part of an illumination device for other analog and digital instruments used in airplanes, cars, automobiles, the cockpit, and so on.

While the invention has been described with reference to several particular embodiments, it is to be understood that these embodiments are merely illustrative of the principles of the invention. Accordingly, the embodiments described in particular should be considered as exemplary, not limiting, with respect to the following claims.

I claim:

1. A watch comprising:
a case with bottom and a crystal disposed generally in parallel to each other, and a continuous sidewall extending around the case;
a watch face having at least a portion disposed at an angle with respect to the crystal;
indicia disposed on said watch face; and
a radiation emitting device arranged in a case to direct radiation to illuminate said indicia.

2. The watch of claim 1 wherein said sidewall is formed with a cavity and said radiation emitting device is disposed in said cavity.

3. The watch if claim 1 wherein said radiation emitting device is an LED.

4. The watch of claim 1 wherein said indicia is formed of a UV sensitive material that renders said indicia visible in the presence of UV radiation, and wherein said radiation emitting device is a UV LED.

5. The watch of claim 4 wherein said crystal is coated with a UV reflective material and said device is arranged to generate some radiation toward the crystal, which radiation is then reflected toward said watch face.

6. The watch of claim 1 wherein said case and said watch face are generally circular.

7. The watch of claim 1 wherein said case and said watch face are generally square.

8. A watch comprising:
a case defining an inner space and having a peripheral wall, a crystal and a bottom, with a corner zone formed between said peripheral wall and said crystal;
a watch face disposed under said crystal;
indicia disposed on said watch face; and
a first radiation emitting device including a radiation source disposed at the corner zone and oriented to direct radiation at said indicia.

9. The watch of claim 8 wherein said watch face includes a portion disposed at an angle with respect to said crystal.

10. The watch of claim 8 wherein said indicia includes a UV reactive material that renders said indicia visible in the presence of UV radiation and wherein said radiation source is a UV LED.

11. The watch of claim 8 wherein said watch face includes a first portion that is angled with respect to said crystal and a second portion that is substantial parallel to said crystal.

12. The watch of claim 8 wherein said watch face includes a first portion and a second portion separate from said first portion, both said portions being angled with respect to said crystal.

13. The watch of claim 11 wherein both portions include indicia defining respective first and second dials.

14. The watch of claim 11 further comprising a separate radiation emitting device for illuminating said second portion.

15. The watch of claim 14 wherein said watch face has straight portion disposed substantially in parallel to the crystal and a second portion disposed substantially at an angle with respect to the crystal, said watch further including a second light source oriented to selectively direct radiation at said second portion.

16. The watch of claim 8 wherein said watch face is parallel to the crystal.

17. The watch of claim 16 wherein said crystal is coated with a UV reflective material.

18. The watch of claim 16 wherein said watch face is coated with a UV reflective material.

19. An illumination device comprising:
a crystal;
a dial disposed under said crystal;
indicia disposed on said dial; and
a radiation emitting device including a radiation source disposed at the corner zone and oriented to direct radiation at said indicia.
